(19) United States
(12) Patent Application Publication
(10) Pub. No.: US 2026/0328117 A1
(43) Pub. Date: Oct. 22, 2026

(54) FORCE-LIMITING BEARING SUPPORT WITH MULTI-CYCLE ENERGY ABSORPTION

(71) Applicant: Pratt & Whitney Canada Corp., Longueuil (CA)

(72) Inventors: Nathan Tomes, Hamilton (CA); Tyler Richardson, Toronto (CA)

(21) Appl. No.: 19/182,058

(22) Filed: Apr. 17, 2025

(51) Int. Cl. F01D 25/16; F01D 21/04

(52) U.S. Cl. CPC F01D 25/164; F01D 21/04; F05D 2220/323; F05D 2240/50; F05D 2260/96

(57) ABSTRACT

An annular bearing element is provided and includes an annular ring having opposed first and second axial sides and opposed interior and exterior surfaces, radial extension members extending radially outwardly from a circumferential array of points at the exterior surface and axial extension members. Each axial extension member extends axially toward one of the opposed first and second axial sides from an outboard end of a corresponding one of the radial extension members and terminates at or beyond the one of the opposed first and second axial sides.

### BACKGROUND

The present disclosure relates to aircraft gas turbine engines and, in particular, to a force-limiting bearing support with multi-cycle energy absorption.

Aircraft engine fans are designed to resist damage caused by foreign object ingestion. However, in certain circumstances, a fan may be damaged to such an extent that parts of one or more of the fan blades become detached from the rotor disk (referred to herein as a fan blade off event or FBO event). This may result in a significant imbalance requiring shutdown of the engine to minimize load transmission to the aircraft. The imbalance in the fan created by the blade loss generates extremely high radial loads which must at least be partially absorbed as the engine is run down to windmilling speed (i.e., the speed at which the rotor spins in a non-operative condition as a result of the aircraft moving through the air).

Under certain circumstances, the vibration resulting from the fan imbalance at windmilling speed can still be considerable. If not appropriately controlled, these vibrations may damage the engine structure and the aircraft and present control difficulties.

### SUMMARY

According to an aspect of the disclosure, an annular bearing element is provided and includes an annular ring having opposed first and second axial sides and opposed interior and exterior surfaces, radial extension members extending radially outwardly from a circumferential array of points at the exterior surface and axial extension members. Each axial extension member extends axially toward one of the opposed first and second axial sides from an outboard end of a corresponding one of the radial extension members and terminates at or beyond the one of the opposed first and second axial sides.

In accordance with one or more additional and/or alternative embodiments, the radial extension members extend in parallel with a radial dimension of the annular ring and have uniform circumferential spacing.

In accordance with one or more additional and/or alternative embodiments, the radial extension members have uniform 45 degree circumferential spacing.

In accordance with one or more additional and/or alternative embodiments, the radial extension members extend radially outwardly from the circumferential array of the points at the exterior surface and at the first axial side, and each of the axial extension members extends axially toward the second axial side from the outboard end of the corresponding one of the radial extension members and terminates at or beyond the second axial side.

In accordance with one or more additional and/or alternative embodiments, the axial extension members are parallel with the exterior surface.

According to an aspect of the disclosure, an annular bearing element is provided and includes an annular ring having opposed first and second axial sides and opposed interior and exterior surfaces, a radially outwardly extending flange extending radially outwardly from the exterior surface at a part-way between the first and second axial sides and first and second axial extension members. Each first axial extension member extends axially toward the first axial side from a first side of an outboard edge of the radially outwardly extending flange and terminates at or beyond the first axial side. Each second axial extension member extends axially toward the second axial side from a second side of the outboard edge of the radially outwardly extending flange and terminates at or beyond the second axial side.

In accordance with one or more additional and/or alternative embodiments, the radially outwardly extending flange extends radially outwardly from the exterior surface at a halfway-point between the first and second axial sides.

In accordance with one or more additional and/or alternative embodiments, the first and second axial extension members are parallel with the exterior surface.

According to an aspect of the disclosure, a force-limiting bearing support with multi-cycle energy absorption assembly is provided for mitigating imbalance in an engine due to a fan blade off (FBO) event. The force-limiting bearing support with multi-cycle energy absorption assembly includes an annular flange fixed to a casing of the engine, spokes extending radially inwardly from the annular flange, an annular bearing element comprising hooks and a buckling membrane attached to respective interior ends of each of the spokes to radially restrain the annular bearing element against loading up to a designed buckling load, which is less than or equal to loading of the FBO event, to sequentially buckle under excessive loading beyond the designed buckling load and to be sequentially recovered by the hooks upon annular bearing element rotation.

In accordance with one or more additional and/or alternative embodiments, during the excessive loading, the buckling membrane remains buckled and the spokes act as bumpers for radially restraining the annular bearing element, and, following cessation of the excessive loading, the hooks sequentially return the buckling membrane to an initial shape thereof.

In accordance with one or more additional and/or alternative embodiments, the buckling membrane includes metallic material.

In accordance with one or more additional and/or alternative embodiments, the buckling membrane includes discrete segments between neighboring spokes, each discrete segment having an initial shape characterized in that each discrete segment is curved radially inwardly for loading up to the designed buckling load.

In accordance with one or more additional and/or alternative embodiments, respective ends of each of the discrete segments are connected to an interior end of a corresponding spoke at a pin joint.

In accordance with one or more additional and/or alternative embodiments, respective ends of each of the discrete segments are welded to an interior end of a corresponding spoke.

In accordance with one or more additional and/or alternative embodiments, the annular bearing element further includes an annular ring having opposed first and second axial sides and opposed interior and exterior surfaces, and the hooks include radial extension members extending radially outwardly from a circumferential array of points at the exterior surface and axial extension members for recovering a corresponding one of the discrete segments, each axial extension member extending axially toward one of the opposed first and second axial sides from an outboard end of a corresponding one of the radial extension members and terminating at or beyond the one of the opposed first and second axial sides.

In accordance with one or more additional and/or alternative embodiments, the radial extension members extend in parallel with a radial dimension of the annular ring and have uniform circumferential spacing.

In accordance with one or more additional and/or alternative embodiments, the radial extension members extend radially outwardly from the circumferential array of the points at the exterior surface and at the first axial side, and each of the axial extension members extends axially toward the second axial side from the outboard end of the corresponding one of the radial extension members and terminates at or beyond the second axial side.

In accordance with one or more additional and/or alternative embodiments, the axial extension members are parallel with the exterior surface.

In accordance with one or more additional and/or alternative embodiments, the annular bearing element further includes an annular ring having opposed first and second axial sides and opposed interior and exterior surfaces and a radially outwardly extending flange extending radially outwardly from the exterior surface at a part-way between the first and second axial sides, each of the spokes includes forward and aft spokes to axially restrain the radially outwardly extending flange, the buckling membrane includes a forward buckling membrane attached to the respective interior ends of each of the forward spokes and an aft buckling membrane attached to the respective interior ends of each of the aft spokes and the hooks include first axial extension members for recovering a corresponding discrete segment of the forward buckling membrane, each first axial extension member extending axially toward the first axial side from a first side of an outboard edge of the radially outwardly extending flange and terminating at or beyond the first axial side and second axial extension members for recovering a corresponding one of the discrete segments, each second axial extension member extending axially toward the second axial side from a second side of the outboard edge of the radially outwardly extending flange and terminating at or beyond the second axial side.

In accordance with one or more additional and/or alternative embodiments, the first and second axial extension members are parallel with the exterior surface.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1 is a cross-sectional view of a prior art turbofan engine;

FIG. 2 is a side schematic diagram of a prior art bearing support assembly;

FIG. 3 is a graphical illustration of snap-through buckling in accordance with embodiments;

FIG. 4 is a side schematic diagram of a force-limiting bearing support with recovery capability assembly in accordance with embodiments;

FIG. 5 is an axial view of the force-limiting bearing support with recovery capability assembly of FIG. 4 in accordance with embodiments;

FIG. 6 is a side schematic diagram of a force-limiting bearing support with recovery capability assembly with first and second axial extension members in accordance with embodiments;

FIGS. 7A-7C are graphical illustrations of operations of the force-limiting bearing support with recovery capability assembly of FIG. 4 in accordance with embodiments;

FIG. 8 is an enlarged view illustrating pin joints of the force-limiting bearing support with recovery capability assembly of FIG. 4 in accordance with embodiments; and

FIG. 9 is an enlarged view illustrating welds of the force-limiting bearing support with recovery capability assembly of FIG. 4 in accordance with embodiments.

### DETAILED DESCRIPTION

The following disclosure is applicable to any type of gas turbine engine, including, but not limited to, turbofans, turboshafts, turboprops, turbojets, electrical drives, hybrid drives, etc. The gas turbine engine described below is provided by way of example, and should not be interpreted as limiting the scope of the application or the claims in any way.

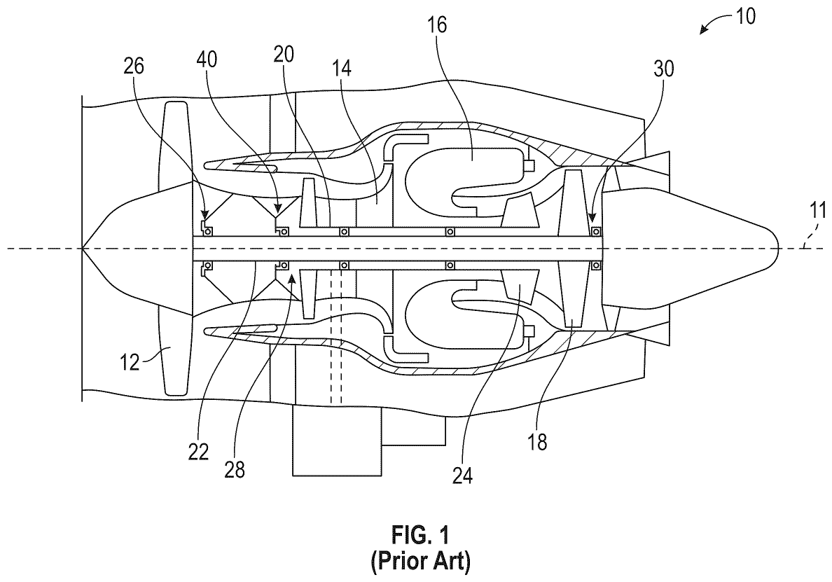

FIG. 1 illustrates a turbofan gas turbine engine 10 of a type provided for use in subsonic flight and generally including a low pressure spool assembly, which includes a fan assembly 12, a low pressure compressor assembly (not shown) and a low pressure turbine assembly 18 connected by a low pressure shaft 22, and a high pressure spool assembly, which includes a high pressure compressor assembly 14 and a high pressure turbine assembly 24 connected by a high pressure shaft 20. The engine 10 further includes a combustor 16 in which compressed air from the high pressure compressor 14 is mixed with fuel and ignited for generating an annular stream of hot combustion gases from which the low pressure and high pressure turbine sections extract energy.

The low pressure spool is rotatably supported by a number of axially spaced-apart bearings concentrically mounted about the central axis 11 of the engine 10. The low pressure shaft 22 is supported at its front or upstream end by first and second bearings 26 and 28 and at a rear end thereof by a third bearing 30. The bearing arrangement for a particular engine, including but not limited to the number and type of bearings selected, is typically determined by a number of factors specific to that engine. The bearing arrangement described herein is exemplary only, and not intended to be limiting. In this example, the first and third bearings 26 and 30 may be roller bearings for radially supporting the low pressure shaft 22 and the second bearing 28 may be a thrust bearing to provide both axial and radial support to the low pressure shaft 22. The first bearing 26 can be disposed adjacent the fan rotor and the second bearing 28 can be disposed adjacent to and downstream from the first bearing 26, and upstream of the high pressure compressor 14 relative to a flow direction of the gases through the engine 10. The bearings and supporting structure flanges may be arranged in any suitable fashion in the context of the present application.

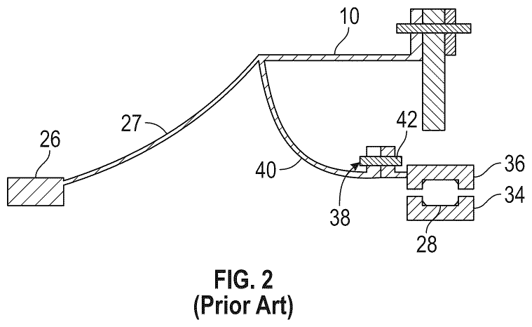

With reference to FIG. 2, the first bearing 26 can be supported on the stator structure of the engine 10 by a first bearing support 27. To minimize the effect of potentially damaging abnormal imbalance loads, such as those caused by FBO-induced imbalance loads, the first bearing support 27 can be designed to be frangible when subject to a predetermined critical load. As shown in FIG. 2, the first bearing support 27 may be provided in the form of a fusible conical structure connected to an outer race of the first bearing 26. The fusible conical structure fails when subject to a critical loading condition to thereby decouple the first bearing 26 from the stator structure of the engine 10. The fusible conical structure decouples the first bearing 26 from the static structure of the engine 10 by buckling, collapsing, crimping, yielding or fracturing. The net result is that the radial support provided to the first bearing 26 is either eliminated or reduced to a negligible value. The second bearing 28 may be provided in the form of a thrust bearing having rolling elements retained by a bearing cage and disposed between inner and outer races 34, 36. The inner race 34 can be securely mounted to the low pressure shaft 22. The outer race 36 has a mounting flange 38 projecting radially outwardly from the front end thereof for connection to a second bearing support 40. The second bearing support 40 can have a frusto-conical shape. A series of circumferentially distributed frangible fasteners, such as fusible or shear bolts 42 or the like, may be used to fasten the mounting flange 38 of the outer race 36 to the bearing support 40. The fusible bolts 42 may shear for structurally decoupling the second bearing 28 from the stator structure of the engine 10, and are sized so that shear preferably occurs after decoupling at the first bearing 26, thereby preventing the transmission of potentially damaging imbalance forces or other vibratory forces to the engine 10 and the airframe in the event of a fan blade loss or another abnormal fan rotor imbalance event.

It is often the case that, during an FBO event, some engine architectures are designed to require that the first and second bearings 26 and 28 break to help prevent loads and vibrations caused by imbalances from being transferred from the rotor to the engine 10 and ultimately to the aircraft structure. It has been found, however, that designing the fusible or shear bolts 42 to always break at FBO (requiring high stress) but not yield at limit loads or installation and have a full lifespan (all requiring low stress) is difficult.

A need therefore exists for an engine architecture in which at least the second bearing support for the second bearing described above is broken due to buckling at stresses below yield.

Thus, as will be described below, a force-limiting bearing support with multi-cycle energy absorption of an aircraft is provided for use in an engine of an aircraft. The force-limiting bearing support with multi-cycle energy absorption is characterized in that a buckling capacity thereof is designed to be greater than ultimate maneuver loads but less than those experienced during FBO. If desirable, the buckling capacity can be set such that collapse only occurs under rundown when a fan resonance occurs that increases the radial forces beyond those during the initial containment event. The post-buckled shape of the force-limiting bearing support with multi-cycle energy absorption can act as a bumper for the bearing without need for additional parts. In the force-limiting bearing support with multi-cycle energy absorption, buckling members are not connected at the center ring to ensure that, under normal operating conditions, the member is only under compression and not tension, buckling membranes are curved in or out of plane such that they form a ‘blister’ shape and points at which the buckling members meet spokes and each other are designed to remain elastic throughout the buckling phenomenon and to act as a pinned joint, allowing relative rotation either through rotationally decoupled connections or through plastic deformation. In any case, the force-limiting bearing support with multi-cycle energy absorption can provide for sufficiently stiff axial support for rotor stability. A shape return feature acts as a hook to engage previously snapped-out membranes in tension, returning them to their original position. This full-cycle reversal occurs on a force-displacement hysteresis and absorbs energy in the process providing damping to the rotor.

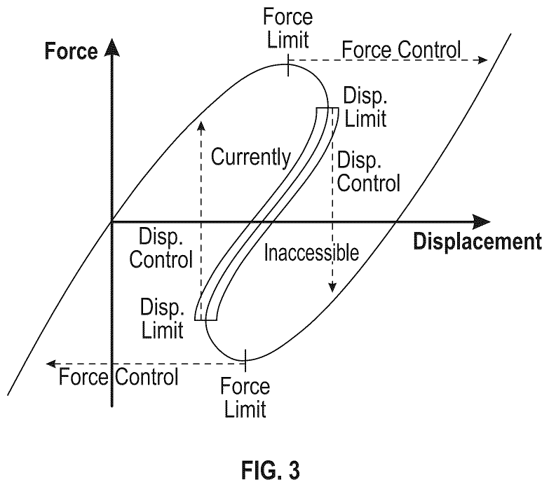

With reference to FIG. 3, snap-back buckling is a phenomenon where a structure has two or more equilibrium states at a given force. As shown in FIG. 3, in the initial loading region, the load-displacement is linear. Once the first limit point is passed, structural resistance force drops and the system ‘snaps’ through to the next equilibrium state. When loaded in the opposite direction, the snap-back occurs along a different path, leading to a hysteresis loop and a loss of energy. In this invention, geometry will be selected such that the structure absorbs significant energy during load-unload or load reversal.

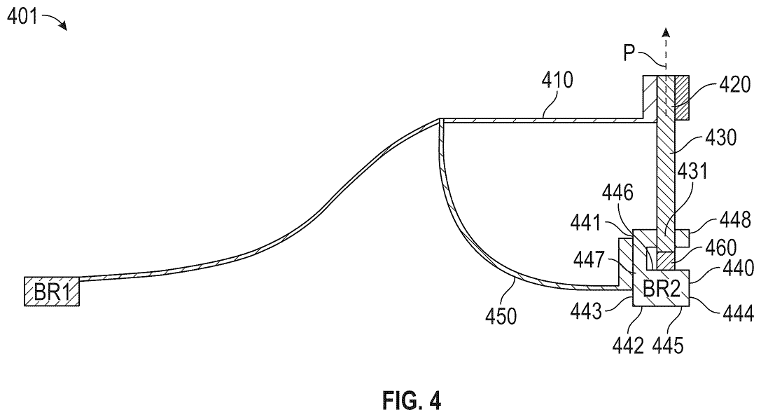

With reference to FIGS. 4-6, a force-limiting bearing support with multi-cycle energy absorption assembly 401 is provided for mitigating imbalance in an engine, such as the engine 10 of FIGS. 1 and 2, due to an FBO event. The force-limiting bearing support with multi-cycle energy absorption assembly 401 includes a casing 410, such as an engine casing, an annular flange 420 that is fixed to the casing 410, spokes 430 that extend radially inwardly from the annular flange 420, an annular bearing element 440, such as an outer race of a bearing (i.e., the second bearing 28 of FIG. 1), an axial restraint 450 and a buckling membrane 460. The spokes 430 are generally arranged in a plane P. The annular bearing element 440 includes hooks 441. The axial restraint 450 is attached at opposite ends thereof to the casing 410 and to the annular bearing element 440 and is configured to axially restrain the annular bearing element 440 relative to the plane P of the spokes 430. The buckling membrane 460 is attached to respective interior ends 431 of each of the spokes 430. The buckling membrane 460 is configured to radially restrain the annular bearing element 440 against loading up to a designed buckling load, which is designed to be less than or equal to loading of the FBO event, to sequentially buckle under excessive loading beyond the designed buckling load and to be sequentially recovered by the hooks 441 upon continued high displacement rotation of the annular bearing element 440.

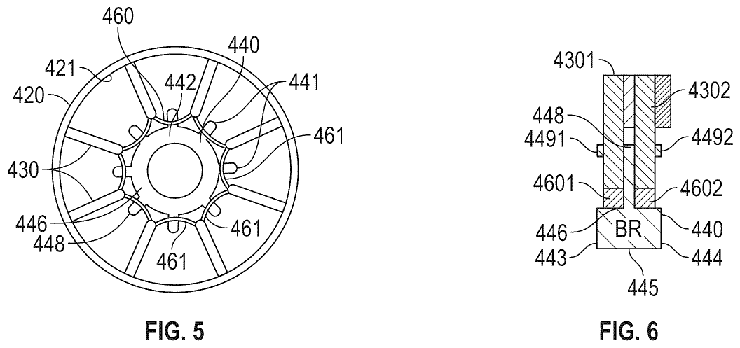

The buckling membrane 460 can include metallic material or some other suitable material and can include discrete segments 461 (see FIG. 5) between neighboring spokes 430. Each discrete segment 461 has an initial shape characterized in that each discrete segment 461 is curved radially inwardly for loading up to the designed buckling load. The annular bearing element 440 includes a sufficient number of hooks 441 such that each of the hooks 441 corresponds to a corresponding one of the discrete segments 461.

As shown in FIGS. 4 and 5, the annular bearing element 440 also includes an annular ring 442 having opposed first and second axial sides 443, 444 and opposed interior and exterior surfaces 445, 446 and the hooks 441 include radial extension members 447 and axial extension members 448. The radial extension members 447 extend radially outwardly from a circumferential array of points at the exterior surface 446. The radial extension members 447 can extend substantially in parallel with a radial dimension of the annular ring 442 and can have uniform circumferential spacing (e.g., of about 45° between neighboring radial extension members 447). The axial extension members 448 are configured for pulling on and thereby recovering the initial shape of the corresponding one of the discrete segments 461. The axial extension members 448 extend axially substantially in parallel with the exterior surface 446 toward one of the opposed first and second axial sides 443, 444 from an outboard end of a corresponding one of the radial extension members 447 and terminate at or beyond the one of the opposed first and second axial sides 443, 444. For example, as shown in FIG. 4A, the radial extension members 447 can extend radially outwardly from the circumferential array of the points at the exterior surface 446 and at the first axial side 443 and each of the axial extension members 448 extends axially toward the second axial side 444 from the outboard end of the corresponding one of the radial extension members 447 and terminates at or beyond a far membrane edge and/or the second axial side 444.

In accordance with embodiments, where the annular bearing element 440 is the outer race of a bearing (i.e., the second bearing 28 of FIG. 1), the opposed first and second axial sides 443, 444 will be generally coplanar with corresponding opposed first and second axial sides of the inner race. In these or other cases, the outermost sides of the radial extension members 447 will be generally coplanar with the corresponding one of the opposed first and second axial sides 443, 444. Thus, a substantial portion of each of the hooks 441 may be substantially coaxial with the annular bearing element 440.

As shown in FIG. 6, the annular bearing element 440 of FIGS. 4 and 5 can also include a radially outwardly extending flange 448 extending radially outwardly from the exterior surface 446 at a part-way (e.g., a mid-point) between the first and second axial sides 443, 444 (see FIGS. 4 and 5). In these or other cases, each of the spokes 430 (see FIGS. 4 and 5) can include forward spokes 4301 and aft spokes 4302 to axially restrain the radially outwardly extending flange 448 and the buckling membrane 460 (see FIGS. 4 and 5) can include a forward buckling membrane 4601, which is attached to the respective interior ends of each of the forward spokes 4301, and an aft buckling membrane 4602, which is attached to the respective interior ends of each of the aft spokes 4202. The forward buckling membrane 4601 and the aft buckling membrane 4602 can have alternating spoke attachment points. This allows shallower snap-through membrane angles while retaining significant displacement, opening the design space to larger combinations of initial stiffness, effective bumper radial position and snap-through force. In addition, in these or other cases, the hooks 441 (see FIG. 4) can include first axial extension members 4491 and second axial extension members 4492. The first axial extension members 4491 are configured for pulling on and thereby recovering the initial shape of the corresponding discrete segment of the forward buckling membrane 4601. Each first axial extension member 4491 extends axially toward the first axial side 443 in parallel with the exterior surface 446 from a first side of an outboard edge of the radially outwardly extending flange 448 and terminates at or beyond the first axial side 443. The second axial extension members 4492 are configured for pulling on and thereby recovering the initial shape of the corresponding discrete segment of the aft buckling membrane 4602. Each second axial extension member 4492 extends axially toward the second axial side 444 in parallel with the exterior surface 446 from a second side of the outboard edge of the radially outwardly extending flange 448 and terminates at or beyond the second axial side 444.

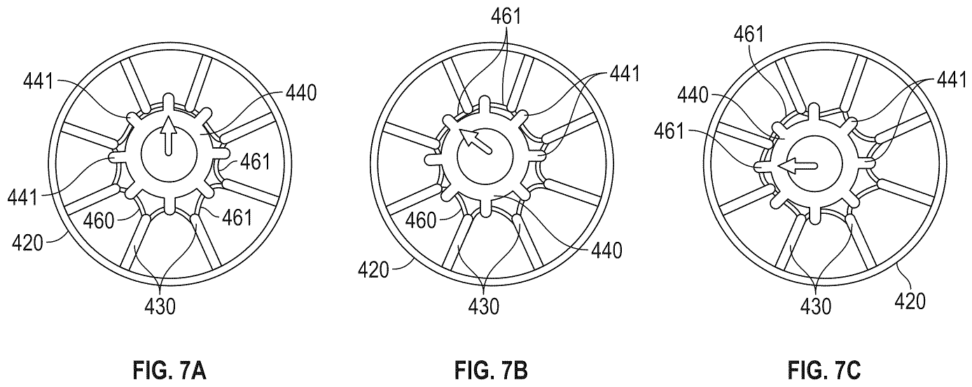

An operation of the buckling membrane 460 is illustrated in FIGS. 7A-7C. As shown in FIG. 7A, during normal engine operations, the annular bearing element 440 is radially restrained by the discrete segments 461 as long as the annular bearing element 440 exerts forces on the discrete segments 461 that are less than the designed buckling load. In this condition, each of the hooks 441 extends around the corresponding one of the discrete segments 461 without mechanically interacting with the corresponding one of the discrete segments 461. As shown in FIG. 7B, the annular bearing element 440 exerts a force that is at least equal to the designed buckling load on one of the discrete segments 461 in accordance with an FBO event. This force causes the one discrete segment 461 to deform and buckle whereupon the annular bearing element 440 becomes offset and the corresponding spokes 430 serve as bumpers for radially restraining the annular bearing element 440. As shown in FIG. 7C, engine rotation continues and the offset annular bearing element 440 causes each of the discrete segments 461 to deform and buckle in sequence. Once each discrete segment 461 deforms and buckles as shown in FIGS. 7B and 7C, the discrete segments 461 remain deformed and buckled for a time during which the corresponding spokes 430 serve as bumpers for radially restraining the annular bearing element 440. After the time, which can be a time required for the annular bearing element 440 to rotate between 90° and 180°, for example, the hooks 441 respectively engage with and pull on the corresponding discrete segments 461 in sequence to thereby cause the discrete segments 461 to sequentially return to their initial shapes.

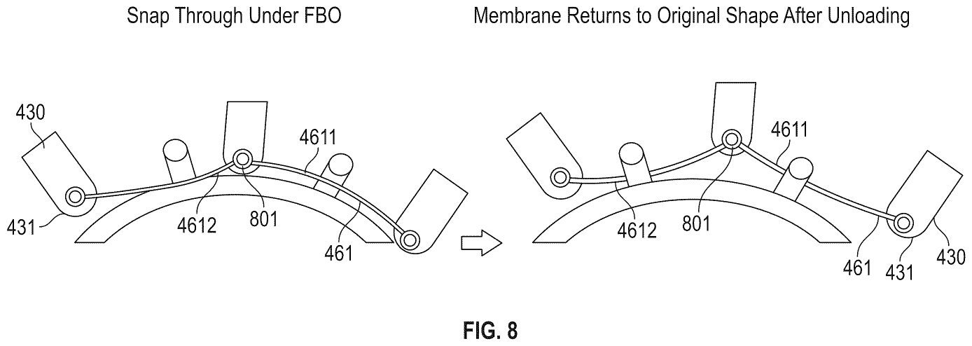

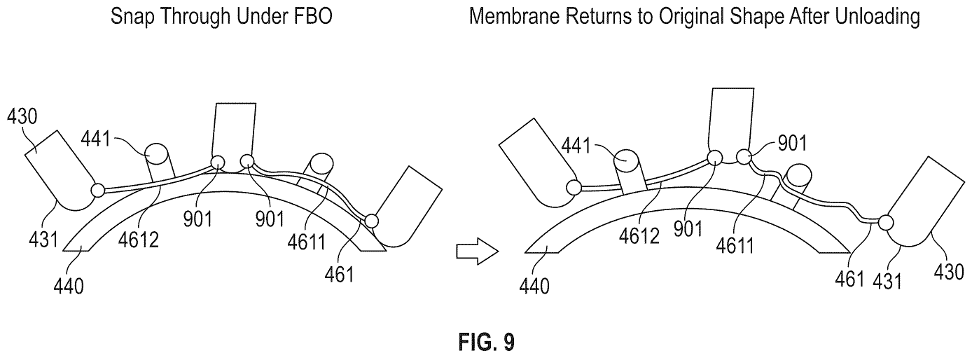

With continued reference to FIGS. 4-6 and FIGS. 7A-7C and with additional reference to FIGS. 8 and 9, respective ends 4611, 4612 of each of the discrete segments 461 can be connected to the interior end 431 of the corresponding spoke 430 at a pin joint 801 (see FIG. 8) and/or the respective ends 4611, 4612 of each of the discrete segments 461 can be welded to the interior end 431 of the corresponding spoke 430 to form a weld 901 (see FIG. 9). In the case of the respective ends 4611, 4612 of each of the discrete segments 461 being connected to the interior end 431 of the corresponding spoke 430 at the pin joint 801 of FIG. 8, overlapped curved ones of the discrete segments 461 can be connected by the pin joint 801 at each spoke 430 and permit local rotation and ultimately snap-through of the discrete segments 461. Thus, a substantial entirety of the discrete segment 461 can elastically or plastically deform and buckle. In the case of the respective ends 4611, 4612 of each of the discrete segments 461 being welded to the interior end 431 of the corresponding spoke 430 to form the weld 901 of FIG. 9, the welds 901 do not permit local rotation leading to plastic deformation of the discrete segments near the welds 901. Thus, in these or other cases, a partial length of the discrete segment 461 can plastically deform and buckle.

Technical effects and benefits of the present disclosure are the provision of a force-limiting bearing support with multi-cycle energy absorption assembly that uses an innovative snap-through buckling design to provide bearing support. This provides for an engine architecture in which at least the second bearing support for the second bearing can be broken due to buckling. This, in turn, provides for easier designing for increased lifespan and limiting loading.

The corresponding structures, materials, acts and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure for various embodiments with various modifications as are suited to the particular use contemplated.

While the preferred embodiments to the disclosure have been described, it will be understood that those skilled in the art, both now and in the future, may make various improvements and enhancements which fall within the scope of the claims which follow. These claims should be construed to maintain the proper protection for the disclosure first described.

1. An annular bearing element of a force limiting bearing support comprising spokes extending radially inwardly from an annular flange and a buckling membrane attached to interior ends of each of the spokes to restrain the annular bearing element, the annular bearing element comprising:
an annular ring having opposed first and second axial sides and opposed interior and exterior surfaces;
radial extension members extending radially outwardly from a circumferential array of points at the exterior surface; and
axial extension members, each axial extension member extending axially toward one of the opposed first and second axial sides from an outboard end of a corresponding one of the radial extension members and terminating at or beyond the one of the opposed first and second axial sides,
the radial extension members and the axial extension members forming hooks to recover the buckling membrane following a buckle of the buckling membrane.

2. The annular bearing element according to claim 1, wherein the radial extension members extend in parallel with a radial dimension of the annular ring and have uniform circumferential spacing.

3. The annular bearing element according to claim 1, wherein the radial extension members have uniform 45 degree circumferential spacing.

4. The annular bearing element according to claim 1, wherein:
the radial extension members extend radially outwardly from the circumferential array of the points at the exterior surface and at the first axial side, and
each of the axial extension members extends axially toward the second axial side from the outboard end of the corresponding one of the radial extension members and terminates at or beyond the second axial side.

5. The annular bearing element according to claim 1, wherein the axial extension members are parallel with the exterior surface.

6. An annular bearing element of a force limiting bearing support comprising spokes extending radially inwardly from an annular flange and a buckling membrane attached to interior ends of each of the spokes to restrain the annular bearing element, the annular bearing element comprising:
an annular ring having opposed first and second axial sides and opposed interior and exterior surfaces;
a radially outwardly extending flange extending radially outwardly from the exterior surface at a part-way between the first and second axial sides;
first axial extension members, each first axial extension member extending axially toward the first axial side from a first side of an outboard edge of the radially outwardly extending flange and terminating at or beyond the first axial side; and
second axial extension members, each second axial extension member extending axially toward the second axial side from a second side of the outboard edge of the radially outwardly extending flange and terminating at or beyond the second axial side,
the radially outwardly extending flange and the first and second axial extension members forming hooks to recover the buckling membrane following a buckle of the buckling membrane.

7. The annular bearing element according to claim 6, wherein the radially outwardly extending flange extends radially outwardly from the exterior surface at a halfway-point between the first and second axial sides.

8. The annular bearing element according to claim 6, wherein the first and second axial extension members are parallel with the exterior surface.

9. A force-limiting bearing support with multi-cycle energy absorption assembly for mitigating imbalance in an engine due to a fan blade off (FBO) event, the force-limiting bearing support with multi-cycle energy absorption assembly comprising:
an annular flange fixed to a casing of the engine;
spokes extending radially inwardly from the annular flange;
an annular bearing element comprising hooks; and
a buckling membrane attached to respective interior ends of each of the spokes to radially restrain the annular bearing element against loading up to a designed buckling load, which is less than or equal to loading of the FBO event, to sequentially buckle under excessive loading beyond the designed buckling load and to be sequentially recovered by the hooks upon annular bearing element rotation.

10. The force-limiting bearing support with multi-cycle energy absorption assembly according to claim 9, wherein:
during the excessive loading, the buckling membrane remains buckled and the spokes act as bumpers for radially restraining the annular bearing element, and following cessation of the excessive loading, the hooks sequentially return the buckling membrane to an initial shape thereof.

11. The force-limiting bearing support with multi-cycle energy absorption assembly according to claim 9, wherein the buckling membrane comprises metallic material.

12. The force-limiting bearing support with multi-cycle energy absorption assembly according to claim 9, wherein the buckling membrane comprises discrete segments between neighboring spokes, each discrete segment having an initial shape characterized in that each discrete segment is curved radially inwardly for loading up to the designed buckling load.

13. The snap-through buckling bearing support assembly according to claim 12, wherein respective ends of each of the discrete segments are connected to an interior end of a corresponding spoke at a pin joint.

14. The snap-through buckling bearing support assembly according to claim 12, wherein respective ends of each of the discrete segments are welded to an interior end of a corresponding spoke.

15. The snap-through buckling bearing support assembly according to claim 12, wherein:
the annular bearing element further comprises an annular ring having opposed first and second axial sides and opposed interior and exterior surfaces, and
the hooks comprise:
radial extension members extending radially outwardly from a circumferential array of points at the exterior surface; and
axial extension members for recovering a corresponding one of the discrete segments, each axial extension member extending axially toward one of the opposed first and second axial sides from an outboard end of a corresponding one of the radial extension members and terminating at or beyond the one of the opposed first and second axial sides.

16. The snap-through buckling bearing support assembly according to claim 15, wherein the radial extension members extend in parallel with a radial dimension of the annular ring and have uniform circumferential spacing.

17. The snap-through buckling bearing support assembly according to claim 15, wherein:
the radial extension members extend radially outwardly from the circumferential array of the points at the exterior surface and at the first axial side, and
each of the axial extension members extends axially toward the second axial side from the outboard end of the corresponding one of the radial extension members and terminates at or beyond the second axial side.

18. The snap-through buckling bearing support assembly according to claim 15, wherein the axial extension members are parallel with the exterior surface.

19. The snap-through buckling bearing support assembly according to claim 12, wherein:
the annular bearing element further comprises an annular ring having opposed first and second axial sides and opposed interior and exterior surfaces and a radially outwardly extending flange extending radially outwardly from the exterior surface at a part-way between the first and second axial sides,
each of the spokes comprises forward and aft spokes to axially restrain the radially outwardly extending flange,
the buckling membrane comprises a forward buckling membrane attached to the respective interior ends of each of the forward spokes and an aft buckling membrane attached to the respective interior ends of each of the aft spokes, and
the hooks comprise:
first axial extension members for recovering a corresponding discrete segment of the forward buckling membrane, each first axial extension member extending axially toward the first axial side from a first side of an outboard edge of the radially outwardly extending flange and terminating at or beyond the first axial side; and
second axial extension members for recovering a corresponding one of the discrete segments, each second axial extension member extending axially toward the second axial side from a second side of the outboard edge of the radially outwardly extending flange and terminating at or beyond the second axial side.

20. The snap-through buckling bearing support assembly according to claim 19, wherein the first and second axial extension members are parallel with the exterior surface.
